(19) United States
(12) Patent Application Publication
(10) Pub. No.: US 2007/0202926 A1
(43) Pub. Date: Aug. 30, 2007

(54) Method for routing audio in a mobile communication device and mobile communication device using same

(76) Inventors: Edward L. Gilmore II, Sunrise, FL (US); Charbel Khawand, Miami, FL (US); Hai-Ning Li, Nanjing (CN); Bill Yim, Lauderhill, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/363,613

(22) Filed: Feb. 28, 2006

(51) Int. Cl. H04B 1/38

(52) U.S. Cl. 455/567

(57) ABSTRACT

A mobile communication device (100) has a plurality of associated ringers for alerting a user to the occurrence of an incoming call (310). The mobile communication device rings a first ringer (312) for a predetermined number of rings or for a predetermined duration. If the call is not answered while ringing the first ringer, the mobile communication device uses other ringers. Each other ringer is associated with an audio device for the user to listen to call audio. Upon answering the call (314), the mobile communication device routes the call audio to the audio device associated with the ringer that was ringing when the user answered the call (320).

### TECHNICAL FIELD

This invention relates in general to mobile communication devices, and more particularly to mobile communication devices having one or more audio accessories associated with the mobile communication device, each of the audio accessories having a ring indicator for indicating an incoming call at the mobile communication device.

### BACKGROUND OF THE INVENTION

Mobile communication devices have gone from being simple radio telephones to multifunction devices, including local wireless networking capability. Consequently, there are a variety of devices and accessories that can be attached to or associated with mobile communication devices. One of the most common accessories is a remote headset. When a user is wearing a headset, and an incoming call is received, the mobile communication device may cause a ringer or call indicator in the accessory to activate to alert the user to the incoming call. Upon perceiving the call alert, the user may answer the call, and the mobile communication device will route the audio signal to the accessory.

However, a problem arises when the user has associated an accessory with the mobile communication device, but isn't presently using the accessory even though it is still associated with the mobile communication device. For example, the user may use a wireless headset with the mobile communication device, but may have taken it off. Upon receiving an incoming call, the mobile communication device may route the call alert to the wireless headset, only the user may not perceive the call alert while not wearing the headset. Consequently the user may miss the call. Therefore there is a need for a way in which a user can still be made aware of an incoming call when not presently using a given accessory to which call alerts may be routed.

### BRIEF DESCRIPTION OF THE DRAWINGS

FIG. 1 shows a block schematic diagram of a mobile communication device, in accordance with an embodiment of the invention;

FIG. 2 shows a learned ringer list structure, in accordance with an embodiment of the invention;

FIG. 3 shows a flowchart diagram of a method of routing audio in a mobile communication device, in accordance with an embodiment of the invention; and

FIG. 4 shows a method of maintaining a learned ringer list, in accordance with an embodiment of the invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

The invention solves the problem of ringing a ringer associated with a mobile communication device which will be heard and responded to by a user of the mobile communication device, and subsequently routing audio to a speaker device associated with the ringer by following a specified ring sequence. The sequence may be generated automatically or it may be a fixed sequence. The sequence starts by ringing a first ringer, which may be disposed in a headset associated with the mobile communication device. If the call is not answered within a prescribed number of rings, the mobile communication device rings a second ringer. Each ringer associated with the mobile communication device may be rung in order, and at some point all ringers may be rung at the same time. If the user answers the call at ringer subsequent to the first ringer, the mobile communication device may adjust the order of ringing for the next received call.

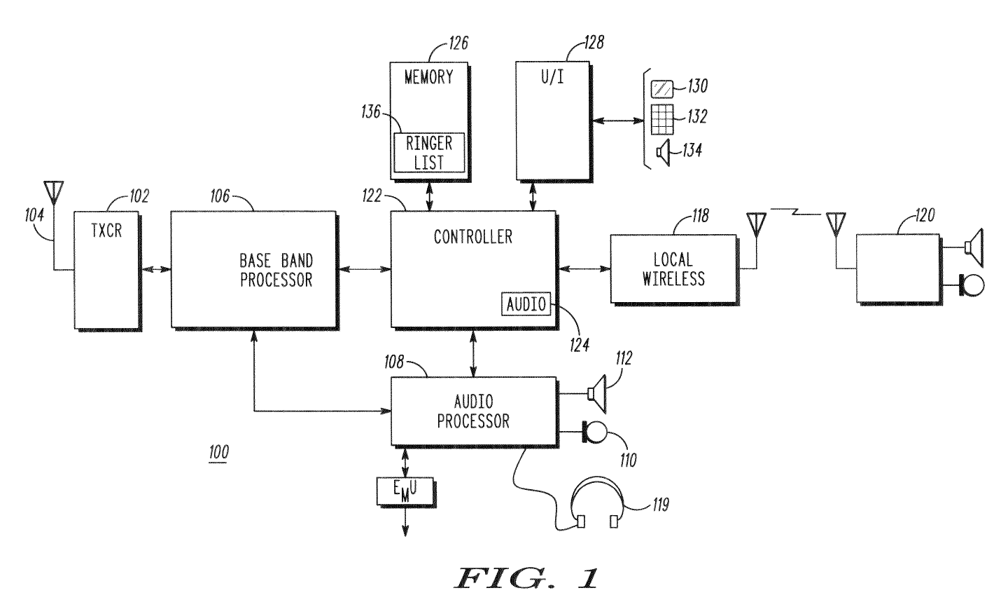

Referring now to FIG. 1, there is show a block schematic diagram 100 of a mobile communication device in accordance with an embodiment of the invention. The mobile communication device may be a cellular telephone or similar device, including a cordless telephone handset. The mobile communication device comprises a mobile communications transceiver 102 which modulates and demodulates, filters, and amplifies signals sent and received over an antenna 104, according to know air interface protocols. The transceiver 102 is coupled to a baseband processor 106, which digitally processes information to be transmitted by, or which has received from the transceiver 102. The baseband processor, for example, encodes voice signals and applies forward error correction as well as digital filtering and other digital processing. The baseband processor 106 is coupled to an audio processor 108. The audio processor converts analog signals of an acoustic origin to digital signals, and vice versa. For example, when a user of the mobile communication device speaks, a microphone 110 converts the acoustic signal to an analog electrical signal, which is processed and digitized by the audio processor to produce a digital signal which is fed to the baseband processor. Similarly, the baseband processor receives demodulated signals from the transceiver, and processes them to provide digital audio signals to the audio processor, which in turn converts them to analog signals that are played over a speaker 112. The audio processor may support additional audio devices, such as a headset 114 and audio accessories connected over, for example, an extended mode universal serial bus (EMU) 116. Other audio accessories may be associated with the mobile communication device, such as by a local wireless transceiver 118 which may be used to link with a wireless headset 120 over a low power radio frequency link. The wireless headset includes speaker and microphone elements as in a conventional headset like headset 114. The wireless headset also contains digital processing elements to convert signals between analog and digital form, with the link between the wireless headset and the local wireless transceiver being digital. The local wireless transceiver is coupled to a controller or application processor 122, which is the central processor of the mobile communication device, and is coupled to all major subsystems of the mobile communication device. The controller executes an audio application 124 for performing audio routing and ringer control, in accordance with an embodiment of the intention. The audio application may be implemented in software, using operating system elements instantiated in the mobile communication device's software architecture. Application programs and data structures used by application programs may be stored in a memory 126 of the mobile communication device. Although represented here abstracted as a single block, practitioners in the art will appreciate that there may be multiple memory elements including a variety of memory types, such as, for example, RAM, ROM, volatile, non-volatile, flash, and so on. The controller also operates a user interface 128, also abstracted here as a single block, and it will likewise be appreciated that the user interface involves a variety of hardware and software elements for allowing a user of the mobile communication device to interact with mobile communication device, including inputting information and commands, receiving information and alerts and so on. The primary interface elements include a graphical display 130, keypad and buttons 132, and an audio transducer 134 for producing audible alerts, such as ringing when a call is attempting to be made to the mobile communication device.

According to the invention, the mobile communication device operates with a plurality of associated ringer, including, for example, a built-in ringer 134, the ringer elements in a wireless headset 120, a conventional headset 114, or audio accessories attached via a bus 116. Each of these ringer elements may have audio, visual, and/or tactile elements, or combinations thereof. Although the term “ringer” has conventionally referred to audio elements, visual and tactile elements (such as vibrators) are now commonly used to alert a user to, for example, incoming calls. Each ringer has, associated with it, an audio transducer to which audio signals are routed. For example, the built-in ringer of the mobile communication device may be associated with an earpiece speaker 112, or a headset 114 if present. As a further example, the wireless headset 120 may use a speaker as both a ringer and for playing audio signals of a call. The mobile communication device maintains a ringer list 136, for example, in the memory 126. The ringer list may be a dynamically maintained list, and specifies a ringer order in which to ring the various ringers presently associated with the mobile communication device. The ringer list further indicates the audio port associated with a given ringer to which audio is to be routed during a call, after the ring is answered by the user of the mobile communication device. Furthermore, the ringer list may indicate the number of rings or period of time a given ringer is active before changing to the next ringer in the list if the ring is not answered while ringing a given ringer. A ringer, as meant here, is generally an incoming call indicator which alerts a user of the mobile communication device that the communication system is attempting to connect a call to the mobile communication device. The term ringer is not used here to refer to a “ring tone” or other file or pattern of activating a call indicating device, element, or hardware component. As mentioned, a ringer may be implemented in a variety of perceptible forms including audible, visual, and tactile forms. Accordingly, ringing a ringer refers to activating the call indicator's perceivable action in a manner intended to get the attention of a user for informing the user that a call is being made to the mobile communication device.

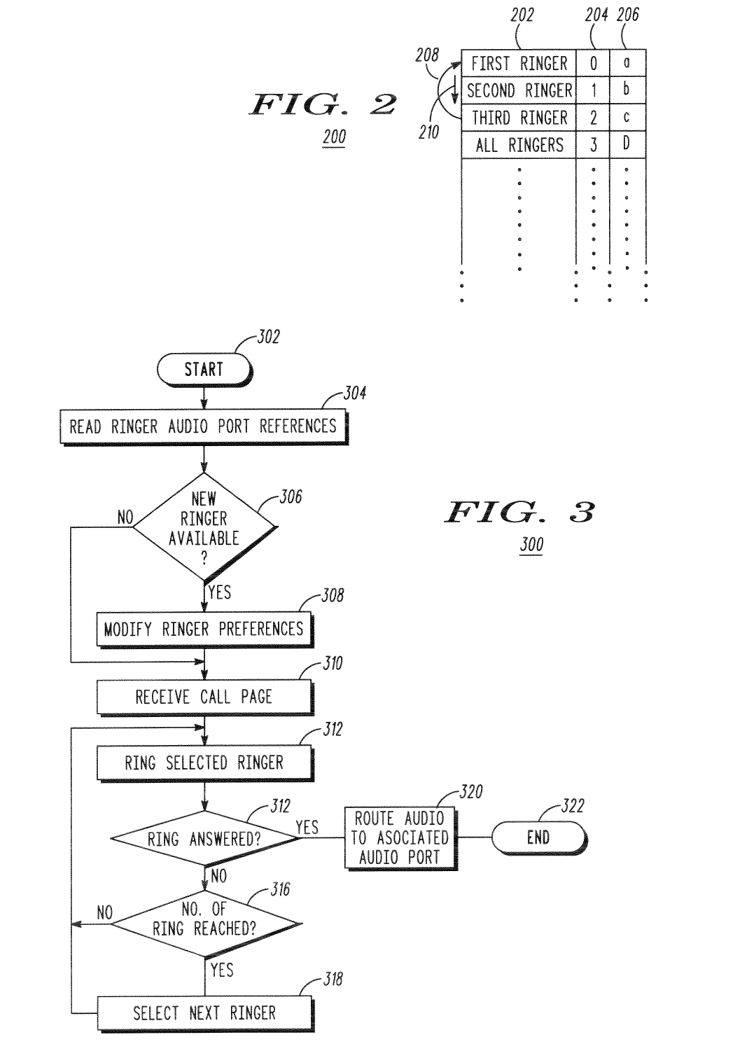

Referring now to FIG. 2, there is shown a learned ringer list structure 200, in accordance with an embodiment of the invention. The learned ringer list is stored in a memory of the mobile communication device, and is dynamically maintained in accordance with a set of rules and/or user preference. The learned ringer list includes a ringer field 202 which identifies a ringer associated with the mobile communication device. Examples of ringers that may be associated with the mobile communication device include a built-in ringer, a ringer in a wireless headset, and a ringer in an associated audio accessory connected by a bus or other means. Associated with each ringer identifier is an audio port field 204 which identifies an audio port to which the mobile communication device will route audio if a call is answered while ringing the ringer. The learned ringer list further may include a ring number field 206 which indicates the number of rings, period of activation, or some other durational limitation associated with each ringer. The ring number field indicates how long the mobile communication device will ring the ringer before moving on to the next ringer in the list. The list is dynamic. If a new audio device is connected to the mobile communication device, for example, the ringer of that audio device and that audio device's audio port may be put at the top of the list on the assumption that the user intends to use the audio device to conduct calls. And similarly, if an audio device is removed or disconnected from the mobile communication device, its entry in the list is removed, and those below it are shifted up. Furthermore, if, when the mobile communication device received an incoming call page, and begins ringing the ringers, and, for example, is ringing the third ringer in the list when the user answers the call, the mobile communication device may assume that the user intends to answer calls when the present third ringer is rung, and so moves it up to the top of the list as indicated by arrow 208, and accordingly moves the other ringers down the list as indicated by arrow 210. It is also contemplated that the ringer list may be changed or adjusted via a user interface application. The user may specify the ring order, the duration or number of rings, and so on.

Referring now to FIG. 3, there is shown a flowchart diagram 300 of a method of routing audio in a mobile communication device, in accordance with an embodiment of the invention. The method specified here serves as an example of one way in which the invention may be performed. At the start 302 the mobile communication device is powered on. During an initialization process the mobile communication device may read a stored ringer list 304 from memory or user preferences. The ringer list includes audio porting or routing information and may further include ring number or other durational limits for ringing a given ringer. The mobile communication device may also detect the presence of a new ringer 306, such as when a headset or other audio accessory is attached, couple to, or otherwise associated with the mobile communication device. If a new ringer becomes available, the mobile communication device may modify the ringer list 308 by, for example, placing the new ringer at the top of the list so that it will be the first ringer to be rung upon occurrence of an incoming call. The new ringer detection may be triggered, for example, by an interrupt process upon association of the new audio device with the mobile communication device. At some point, the mobile communication device receives an incoming call page 310. Upon receipt of the call page, the mobile communication device commences ringing the first ringer specified in the ringer list 312, and waits for the ring to be answered 314 within ring number or durational limit specified 316. If the ring is not answered within the number of rings or durational limit, the mobile communication device selects the next ringer in the list 318 and repeats the process while ringing the next ringer. This process may be repeated until the call is answered or a maximum number of rings has occurred or all ringers have been processed in the method. If the ring is answered, the mobile communication device commences to route audio content of the call to an audio device associated with the ringer that was ringing when the ring was answered (320), as indicated in the ringer list. Once the audio path has been established, the call commences and the method terminates 322.

Although not shown as a path in FIG. 3, it will be apparent to those skilled in the art that once a maximum number of rings occurs, the method would skip to the end 322, at which the call may be switched to voice mail, for example. Furthermore, it is contemplated that the ringer may be selected by category. Several categories may be defined, such as head sets, the built-in ringer, and other accessories such as local wireless or wired accessories. The user may specify through the user interface the order of these categories for a ring sequence. Furthermore, it is contemplated that more than one ringer may be rung during a given ring cycle or ring period. The mobile communication device may ring one ringer during a first portion of a ring period, and ring a second ringer during a second portion of the ring period. Finally, at some point in the ring sequence, in an attempt to get the user's attention, the mobile communication device may ring all available ringers.

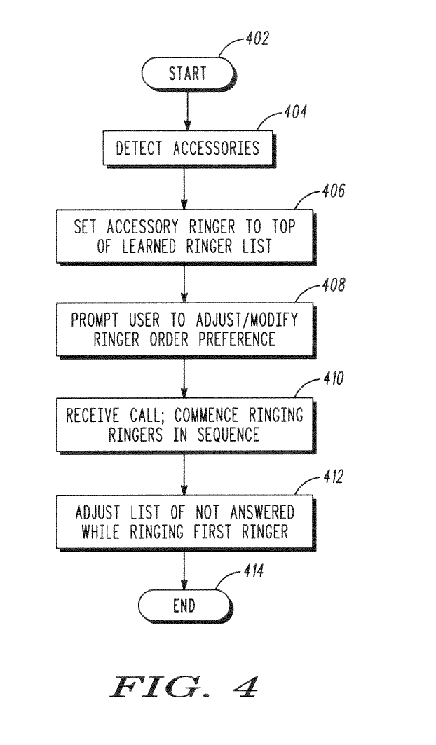

Referring now to FIG. 4, there is shown a flow chart diagram 400 of a method of maintaining a learned ringer list, in accordance with an embodiment of the invention. As described, the ringer list may be dynamically maintained to reflect changes in user preference of ringers or associated ringers, or if a call is answered when ringing a ringer that was not the first ringer in the list. The method commences by initializing the mobile communication device (402). The mobile communication device then detects the associated accessories to register them in the list (404). A rule that may be applied is that the last-connected device is placed at the top of the ringer list on the assumption that the user intends to use that device to communicate, or else would not have attached it. The mobile communication device may also prompt the user to confirm or modify the resulting ringer order (408). Thereafter a call is received. The ringers are rung in the order specified in the ringer list (410). It is contemplated that an option may be allowed where the first two ringers on the list are both rung for half of a ring. The first ringer may be rung for the first half of the ring, and the second ringer may be rung for the second half of the ring. Furthermore, it is contemplated that with each successive ring of a ringer, the ringer quality may be changed, such as by increasing the ringer volume on each successive ring of a given ringer. If the call is answered when ringing a ringer that is not first in the list, the mobile communication device may modify the list by moving the ringer that was ringing when the call was answered to the top of the list (412). Alternatively, the mobile communication device may prompt the user before modifying the list to confirm the user agrees with the change. Once the ringer list is update, if at all, the method terminates (414). It will be appreciated that processes of the method may be invoked at any time, such as upon connection or association with, or disconnection of a device from the mobile communication device, which may result in an interrupt calling processes 406 and 408, for example.

Thus, the invention provides a method for routing audio content in a mobile communication device upon the user of the mobile communication device answering a call. The method commences upon receiving a call alert page at the mobile communication device and subsequently ringing a first ringer associated with the mobile communication device for a preselected number of rings. Upon the user not answering the ring within the preselected number of rings, the method commences by ringing a second ringer associated with the mobile communication device. Upon the user answering the ring while ringing the second ringer, routing call audio to an audio port associated with the second ringer. Of course, one of ordinary skill will realize that there may be more than two ringers associated with the mobile communication device. As such, the term “second ringer” used here is not meant to refer only a ringer used immediately after the first ringer, but to any ringer used subsequent to the first ringer which is ringing when the user answers the call. Thus, the method proceeds from ringer to ringer until the call is answered, and when it is answered, the call audio is routed to the audio device associated with the ringer. Furthermore, although a ringer is conventionally associated with a sound, it will be appreciated that a ringer is generally an incoming call indicator, and my take the form of audio, visual, or other perceptible forms, exclusively or in combination. The ringers may be selected from any of the available ringers, and may be a built-in ringer or an accessory. Furthermore, a learned ringer list may be employed, indicating a ringer order. If the ring is answered while ringing a ringer subsequent to the first ringer, the learned ringer list may be adjusted to move the ringer that was ringing when the call was answered to the top of the list.

The invention also provides a mobile communication device system comprising a plurality of ring indicators. Each of the plurality of ring indicators is for indicating the occurrence of an incoming call received at the mobile communication device. The mobile communication device further has a plurality of audio ports, and each of the plurality of audio ports is associated with one of plurality of ring indicators. Upon receiving an incoming call, the mobile communication device activates a first ring indicator listed in a ringer list. If the user of the mobile communication device does not answer the call within a specified number of rings, the mobile communication device activates a second, subsequent ring indicator. Upon the user answering the ring at the second ring indicator, the mobile communication device commences routing call audio to the audio port associated with the second ring indicator.

The invention further provides a method of maintaining a learned ringer list in a mobile communication device having a plurality of associated ringers, wherein each of the plurality of ringers is associated with one of a plurality of audio ports. The method commences by providing the learned ringer list in a memory of the mobile communication device. The learned ringer list includes a listing of ringers associated with the mobile communication device and indicates a ring order of the ringers. Upon receiving an incoming call at the mobile communication device, the method further commences by ringing a first indicated ringer of the learned ringer list for a preselected number of rings. If the user of the mobile communication device does not answer the incoming call while ringing the first ringer, the mobile communication device commences ringing a second or subsequent indicated ringer of the learned ringer list. Upon the user of the mobile communication device answering the incoming call while ringing the second, subsequent indicated ringer, the mobile communication device commences adjusting the learned ringer list so that the second, subsequent indicated ringer becomes the first indicated ringer.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for routing audio content in a mobile communication device, comprising:
receiving a call alert page at the mobile communication device;
ringing a first ringer associated with the mobile communication device for a preselected number of rings;
upon a user not answering the ring within the preselected number of rings, ringing a second ringer associated with the mobile communication device; and
upon the user answering the ring while ringing the second ringer, routing call audio to an audio port associated with the second ringer.

2. A method for routing audio as defined in claim 1, wherein ringing the first ringer or the second ringer includes generating a visual call indication.

3. A method for routing audio as defined in claim 1, wherein the first ringer is in an associated audio accessory.

4. A method for routing audio as defined in claim 3, wherein the audio accessory is associated with the mobile communication device over a local wireless link.

5. A method for routing audio as defined in claim 3, wherein the second ringer is a built-in ringer of the mobile communication device.

6. A method for routing audio as defined in claim 1, wherein the first ringer is selected from a first entry of a learned ringer list stored in the mobile communication device.

7. A method for routing audio as defined in claim 6, wherein upon the user answering the ring while ringing the second ringer, adjusting the learned ringer list by making the second ringer the first entry in the ringer list and shifting the ringer list down, resulting in the first ringer becoming the second entry in the learned ringer list.

8. A mobile communication device system including a mobile communication device, comprising:
a plurality of ring indicators, each of the plurality of ring indicators for indicating an incoming call at the mobile communication device; and
a plurality of audio ports of the mobile communication device, each of the plurality of audio ports associated with one of plurality of ring indicators; and
wherein upon receiving an incoming call, the mobile communication device activates a first ring indicator of the plurality of ring indicators in the ringer list, and upon a user of the mobile communication device not answering the call upon ringing the first of the plurality of ring indicators within a specified number of rings, the mobile communication device activates a second ring indicator, and wherein upon the user answering the ring at the second ring indicator, routing call audio to the audio port associated with the second ring indicator.

9. A mobile communication device system as defined in claim 8, wherein at least one of the plurality of ring indicators is a visual ring indicator.

10. A mobile communication device system as defined in claim 8, wherein the first ring indicator is in an associated audio accessory.

11. A mobile communication device system as defined in claim 10, wherein the audio accessory is associated with the mobile communication device over a local wireless link.

12. A mobile communication device system as defined in claim 10, wherein the second ring indicator is a built-in ringer of the mobile communication device.

13. A mobile communication device system as defined in claim 8, wherein the first ring indicator is selected from a first entry of a learned ringer list stored in the mobile communication device.

14. A mobile communication device system as defined in claim 13, wherein upon the user answering the ring while ringing the second ring indicator, the mobile communication device adjusts the learned ringer list by making the second ringer the first entry in the ringer list and shifting the ringer list down, resulting in the first ringer becoming the second entry in the learned ringer list.

15. A method of maintaining a learned ringer list in a mobile communication device having a plurality of associated ringers, each of the plurality of ringers associated with one of a plurality of audio ports, the method comprising:
providing the learned ringer list in a memory of the mobile communication device, the learned ringer list including a listing of ringers associated with the mobile communication device and indicating a ring order of the ringers;
receiving an incoming call at the mobile communication device;
ringing a first indicated ringer of the learned ringer list for a preselected number of rings;
upon a user of the mobile communication device not answering the incoming call, ringing a second indicated ringer of the learned ringer list; and
upon the user of the mobile communication device answering the incoming call while ringing the second indicated ringer, adjusting the learned ringer list so that the second indicated ringer becomes the first indicated ringer.

16. A method of maintaining a learned ringer list as defined in claim 15, wherein ringing the first indicated ringer comprises ringing a ringer of an associated audio accessory.

17. A method of maintaining a learned ringer list as defined in claim 16, wherein ringing the ringer of the audio accessory is performed over a local wireless link between the mobile communication device and the audio accessory.

18. A method of maintaining a learned ringer list as defined in claim 15, wherein ringing the first indicated ringer or the second indicated ringer includes activating a visual call indicator.

19. A method of maintaining a learned ringer list as defined in claim 15, wherein providing the learned ringer list includes specifying a number of rings for each of the first and second indicated ringers, and wherein the number of rings indicates how many times to ring the first and second indicated ringer.
